(19) United States
(12) Patent Application Publication
(10) Pub. No.: US 2018/0166887 A1
(43) Pub. Date: Jun. 14, 2018

(54) MANAGING ISLANDED POWER SYSTEMS USING BATTERY STATE OF CHARGE AND FREQUENCY

(71) Applicant: UniEnergy Technologies, LLC, Mukilteo, WA (US)

(72) Inventor: David Ridley, Shoreline, WA (US)

(73) Assignee: UniEnergy Technologies, LLC, Mukilteo, WA (US)

(21) Appl. No.: 15/374,837

(22) Filed: Dec. 9, 2016

(51) Int. Cl. H02J 7/00; H02K 7/18; H02P 9/08; H01M 10/42; H01M 10/48; H01M 8/18

(52) U.S. Cl. CPC H02J 7/007; H02K 7/1815; H02K 7/183; H02P 9/08; H01M 2010/4271; H01M 10/425; H01M 10/482; H01M 8/188; H02J 7/0021

(57) ABSTRACT

A battery management system is configured to, in an island mode, cause a frequency adjustment (e.g., by 3 Hz) to voltage in the power system based on a state of charge. The frequency adjustment signals assets (e.g., loads, generators, energy storage devices) electrically coupled to a battery system to reduce or increase power. If the state of charge is below a threshold value, the frequency adjustment may signal a load to be decreased, power generation of a generator to be increased, or power output of an energy storage device to be increased. If the state of charge is above a threshold value, the frequency adjustment may signal a load to be maintained or increased, power generation of a generator to be decreased, or power output of an energy storage device to be decreased. The frequency adjustment may be calculated automatically as a function of the state of charge.

### BACKGROUND

Concerns over the environmental consequences of burning fossil fuels have led to an increasing use of renewable energy generated from sources such as solar and wind. The intermittent and varied nature of such renewable energy sources, however, has made it difficult to fully integrate these energy sources into existing electrical power grids and distribution networks. A solution to this problem has been to employ large-scale electrical energy storage (EES) systems. These systems are widely considered to be an effective approach to improve the reliability, power quality, and economy of renewable energy derived from solar or wind sources.

In addition to facilitating the integration of renewable wind and solar energy, large scale EES systems also may have the potential to provide additional value to electrical grid management, for example: resource and market services at the bulk power system level, such as frequency regulation, spinning reserves, fast ramping capacity, black start capacity, and alternatives for fossil fuel peaking systems; transmission and delivery support by increasing capability of existing assets and deferring grid upgrade investments; peak shaving and power shifting; and micro-grid support.

A micro-grid may be used, for example, to power remote facilities or communities where connections to the main power grid are unavailable, or to provide backup power in the event of an outage in the main power grid. Although use of EES systems in micro-grids is known, there remains a need for improved management of such micro-grids.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a battery system includes a battery management system and at least a first battery (e.g., a redox flow battery, which may be a vanadium redox flow battery). The battery system is operable in an island mode in which the battery system sets voltage and frequency for the power system. The battery management system is configured to, in the island mode, cause a frequency adjustment to the voltage in the power system based on a state of charge of the battery system. The frequency adjustment signals one or more connected assets electrically coupled to the battery system to reduce or increase power based on the frequency adjustment. The connected assets electrically coupled to the battery system may include a load, a generator, and/or an energy storage device.

The frequency adjustment may be associated with the state of charge being below a threshold value. In this situation, the frequency adjustment may signal a load to be decreased, power generation of a generator to be increased, or power output of an energy storage device to be increased.

The frequency adjustment may be associated with the state of charge being above a threshold value. In this situation, the frequency adjustment may signal a load to be maintained or increased, power generation of a generator to be decreased, or power output of an energy storage device to be decreased.

The frequency adjustment may be calculated automatically as a function of the state of charge. For example, the calculation may be based on magnitude and rate of change of the state of charge.

The frequency adjustment may be an increase or decrease of 5 Hz or less, such as an increase or decrease of approximately 3 Hz, or an increase or decrease of approximately 1 Hz. The state of charge of the battery system may be associated with the first battery. If the battery system includes two or more batteries, the state of charge of the battery system may be calculated as a function of charge of the two or more batteries, such as an average charge of the two or more batteries.

In another aspect, a power system includes a battery management system, a first battery, and a power conversion and control module. The battery management system is operable to, in an island mode, send state of charge information to the power conversion and control module. The power conversion and control module is operable to cause a frequency adjustment to the voltage in the power system based on the state of charge information. The frequency adjustment signals one or more connected assets (e.g., loads, generators, and/or energy storage devices) electrically coupled to the power system to reduce or increase power based on the frequency adjustment.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a redox flow battery (RFB) module;

FIG. 2 is an isometric view of the RFB module of FIG. 1 with the outer container removed;

FIGS. 3A and 3B are schematic views of various components of the RFB module of FIGS. 1 and 2;

FIG. 4 is schematic view of a 1 MW site;

FIG. 5 is a schematic view of a 10 MW site;

FIG. 6 is a control diagram for a site, for example, the sites of FIG. 4 or 5;

FIGS. 7-9 are graphical depictions of data regarding capacity management in an exemplary vanadium RFB string;

FIG. 10 is a schematic view of an RFB module showing an exemplary open circuit voltage (OCV) measurement;

FIG. 11 is a schematic view of an RFB module showing exemplary balance of plant (BOP) loads;

FIG. 12 is a schematic view of power delivery to BOP loads in an RFB module; and

FIG. 13 is a block diagram of a micro-grid power system operable in an island mode that transmits adjusted frequency signals to one or more connected assets in accordance with one embodiment of the present disclosure;

FIGS. 14 and 15 are graphs that illustrate power versus frequency characteristics of two exemplary connected assets; and

FIG. 16 is a graph showing how adjusting the frequency of the power system may cause connected assets to change operating state in accordance with one embodiment of the present disclosure.

### DETAILED DESCRIPTION

Embodiments of the present disclosure are directed to a power system (e.g., a micro-grid) comprising a battery system and at least one connected asset (e.g., a load, an energy storage device, or a generator or other power source) in which the battery system is configured to, in an island mode, make a frequency adjustment (i.e., an adjustment to the frequency of the oscillations of alternating current (AC) in the power system) based on a state of charge (SOC) of the battery system. The frequency adjustment signals the load, energy storage, or power generation of a connected asset that is electrically coupled to the battery system to be reduced or increased, depending on the adjustment. This allows the micro-grid to respond dynamically to changing conditions in the battery system. Although other islanded power systems may include assets that detect and respond to changes in voltage or frequency, described embodiments differ from prior systems at least in that they use the SOC of the battery system to calculate particular adjustments to be made.

An introduction to illustrative electrical storage systems and related control systems and design considerations is provided below, along with descriptions of illustrative systems and techniques for managing power systems using frequency adjustments.

### Electrical Energy Storage Systems and Redox Flow Batteries

Electrical energy storage (EES) systems are an effective approach to improve the reliability, power quality, and economy of renewable energy derived from solar or wind sources. Among the most promising large-scale EES technologies are redox flow batteries (RFBs). RFBs are special electrochemical systems that can repeatedly store and convert megawatt-hours (MWhs) of electrical energy to chemical energy and chemical energy back to electrical energy when needed. RFBs are well-suited for energy storage because of their ability to tolerate fluctuating power supplies, bear repetitive charge/discharge cycles at maximum rates, initiate charge/discharge cycling at any state of charge, design energy storage capacity and power for a given system independently, deliver long cycle life, and operate safely without fire hazards inherent in some other designs.

In simplified terms, an RFB electrochemical cell is a device capable of either deriving electrical energy from chemical reactions, or facilitating chemical reactions through the introduction of electrical energy. In general, an electrochemical cell includes two half-cells, each having an electrolyte. The two half-cells may use the same electrolyte, or they may use different electrolytes. With the introduction of electrical energy, species from one half-cell lose electrons (oxidation) to their electrode while species from the other half-cell gain electrons (reduction) from their electrode.

Multiple RFB electrochemical cells electrically connected together in series within a common housing are generally referred to as an electrochemical “stack”. Multiple stacks electrically connected and assembled together in a common container are generally referred to as a “battery,” and multiple batteries electrically connected together are generally referred to as a “string.” Multiple strings electrically connected together are generally referred to as a “site.” A common RFB electrochemical cell configuration includes two opposing electrodes separated by an ion exchange membrane or other separator, and two circulating electrolyte solutions, referred to as the “anolyte” and “catholyte.” The energy conversion between electrical energy and chemical potential occurs instantly at the electrodes when the liquid electrolyte begins to flow through the cells.

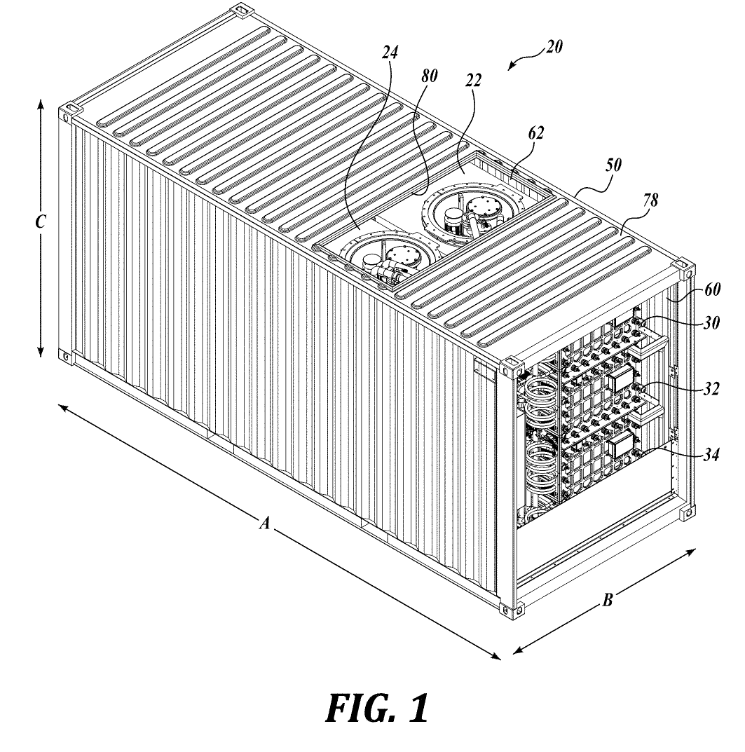

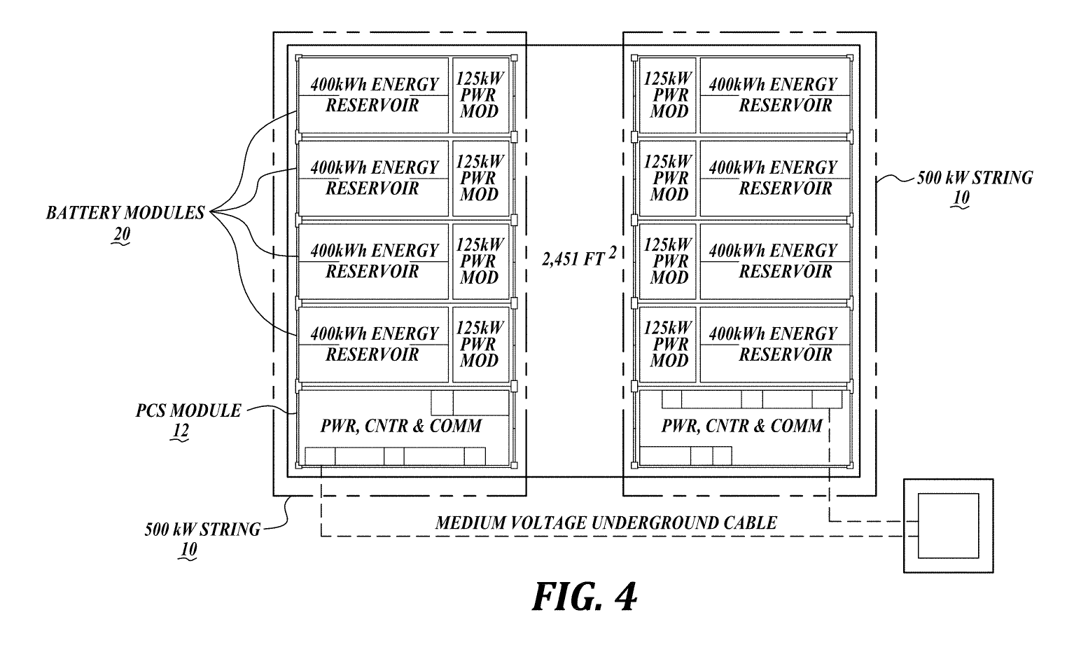

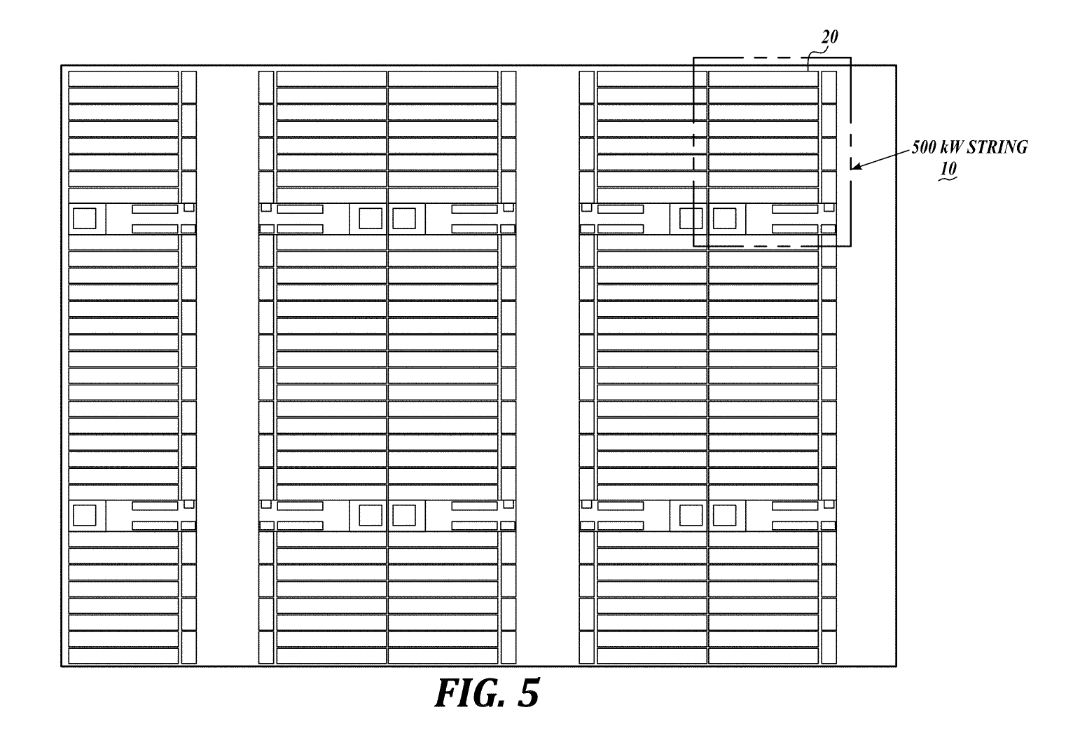

Referring to FIGS. 1-3B, a redox flow battery 20 in accordance with one embodiment of the present disclosure is provided. Multiple redox flow batteries may be configured in a “string” of batteries, and multiple strings may be configured into a “site” of batteries. Referring to FIG. 4, a non-limiting example of a site is provided, which includes two strings 10, each having four RFBs 20. Referring to FIG. 5, another non-limiting example of a site is provided, which includes twenty strings 10, each having four RFBs 20. RFBs, systems and components thereof, stacks, strings, and sites are described in greater detail below.

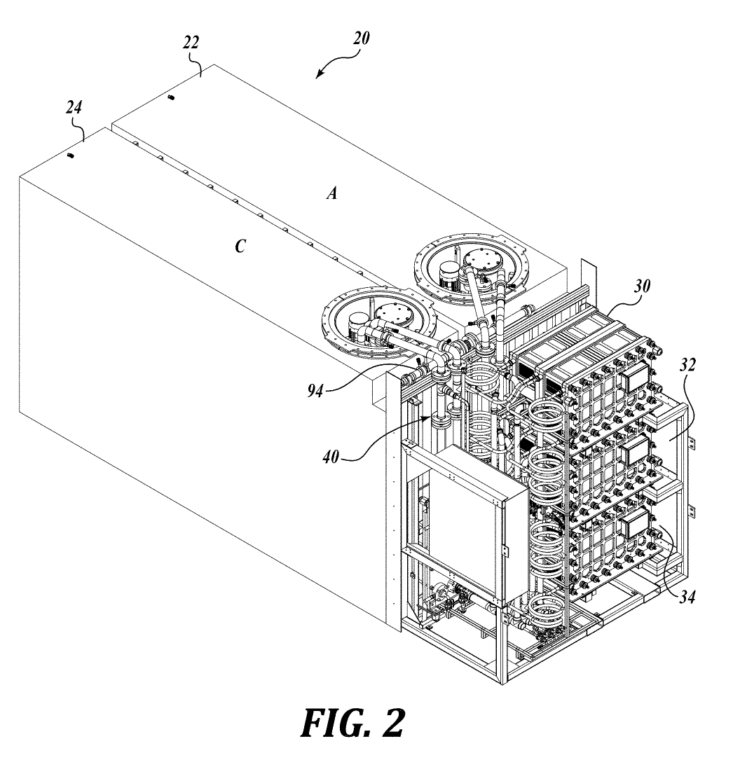

Referring to FIGS. 1 and 2, major components in an RFB 20 include the anolyte and catholyte tank assemblies 22 and 24, the stacks of electrochemical cells 30, 32, and 34, a system for circulating electrolyte 40, an optional gas management system 94, and a container 50 to house all of the components and provide secondary liquid containment.

In the present disclosure, flow electrochemical energy systems are generally described in the context of an exemplary vanadium redox flow battery (VRB), wherein a V³⁺/V²⁺ sulfate solution serves as the negative electrolyte (“anolyte”) and a V⁵⁺/V⁴⁺ sulfate solution serves as the positive electrolyte (“catholyte”). However, other redox chemistries are contemplated and within the scope of the present disclosure, including, as non-limiting examples, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺, etc.

As a non-limiting example, in a vanadium flow redox battery (VRB) prior to charging, the initial anolyte solution and catholyte solution each include identical concentrations of V³⁺ and V⁴⁺. Upon charge, the vanadium ions in the anolyte solution are reduced to V²⁺/V³⁺ while the vanadium ions in the catholyte solution are oxidized to V⁴⁺/V⁵⁺.

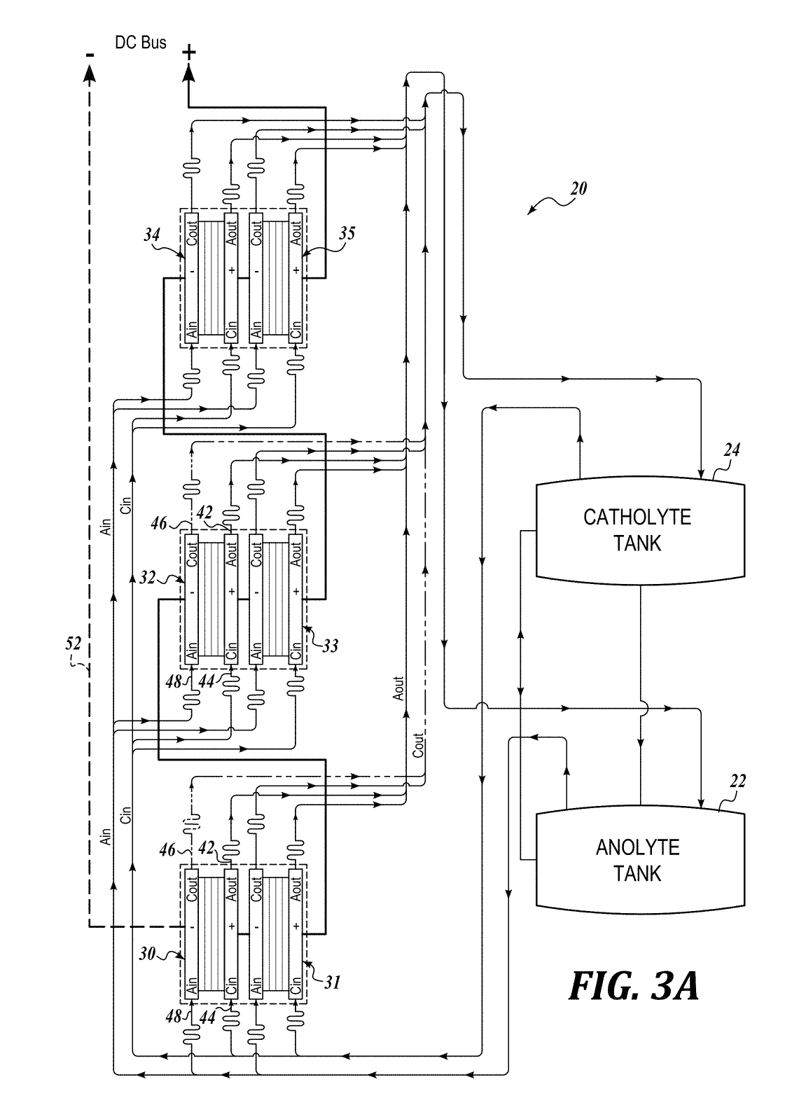

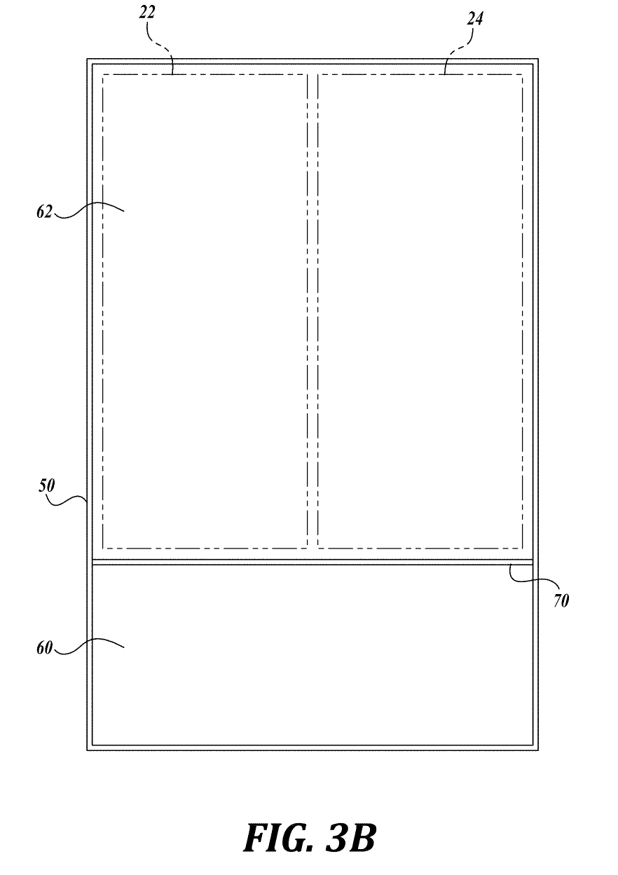

Referring to the schematic in FIG. 3A, general operation of the redox flow battery system 20 of FIGS. 1 and 2 will be described. The redox flow battery system 20 operates by circulating the anolyte and the catholyte from their respective tanks that are part of the tank assemblies 22 and 24 into the electrochemical cells, e.g., 30 and 32. (Although only two electrochemical cells are needed to form a stack of cells, additional electrochemical cells in the illustrated embodiment of FIG. 3A include electrochemical cells 31, 33 and 35.) The cells 30 and 32 operate to discharge or store energy as directed by power and control elements in electrical communication with the electrochemical cells 30 and 32.

In one mode (sometimes referred to as the “charging” mode), power and control elements connected to a power source operate to store electrical energy as chemical potential in the catholyte and anolyte. The power source can be any power source known to generate electrical power, including renewable power sources, such as wind, solar, and hydroelectric. Traditional power sources, such as combustion, can also be used.

In a second (“discharge”) mode of operation, the redox flow battery system 20 is operated to transform chemical potential stored in the catholyte and anolyte into electrical energy that is then discharged on demand by power and control elements that supply an electrical load.

Each electrochemical cell 30 in the system 20 includes a positive electrode, a negative electrode, at least one catholyte channel, at least one anolyte channel, and an ion transfer membrane separating the catholyte channel and the anolyte channel. The ion transfer membrane separates the electrochemical cell into a positive side and a negative side. Selected ions (e.g., H+) are allowed to transport across an ion transfer membrane as part of the electrochemical charge and discharge process. The positive and negative electrodes are configured to cause electrons to flow along an axis normal to the ion transfer membrane during electrochemical cell charge and discharge (see, e.g., line e⁻ in FIG. 3A). As can be seen in FIG. 3A, fluid inlets 48 and 44 and outlets 46 and 42 are configured to allow integration of the electrochemical cells 30 and 32 into the redox flow battery system 20.

To obtain high voltage, high power systems, a plurality of single electrochemical cells may be assembled together in series to form a stack of electrochemical cells (referred to herein as a “stack,” a “cell stack,” or an “electrochemical cell stack”), e.g., 30 or 32 in FIG. 3A. Several cell stacks may then be further assembled together to form a battery system 20. Stacks may be connected in strings in series or in parallel. A MW-level RFB system generally has a plurality of cell stacks, for example, with each cell stack having more than twenty electrochemical cells. As described for individual electrochemical cells, the stack is also arranged with positive and negative current collectors that cause electrons to flow through the cell stack generally along an axis normal to the ion transfer membranes and current collectors during electrochemical charge and discharge (see, e.g., line 52 shown in FIG. 3A).

At any given time during battery system 20 charging or discharging mode, reactions only occur for the electrolyte that is contained inside electrochemical cells. The energy stored in the battery system 20 increases or decreases according to the charging and discharging power applied to the electrochemical cells.

### String and Site Control System

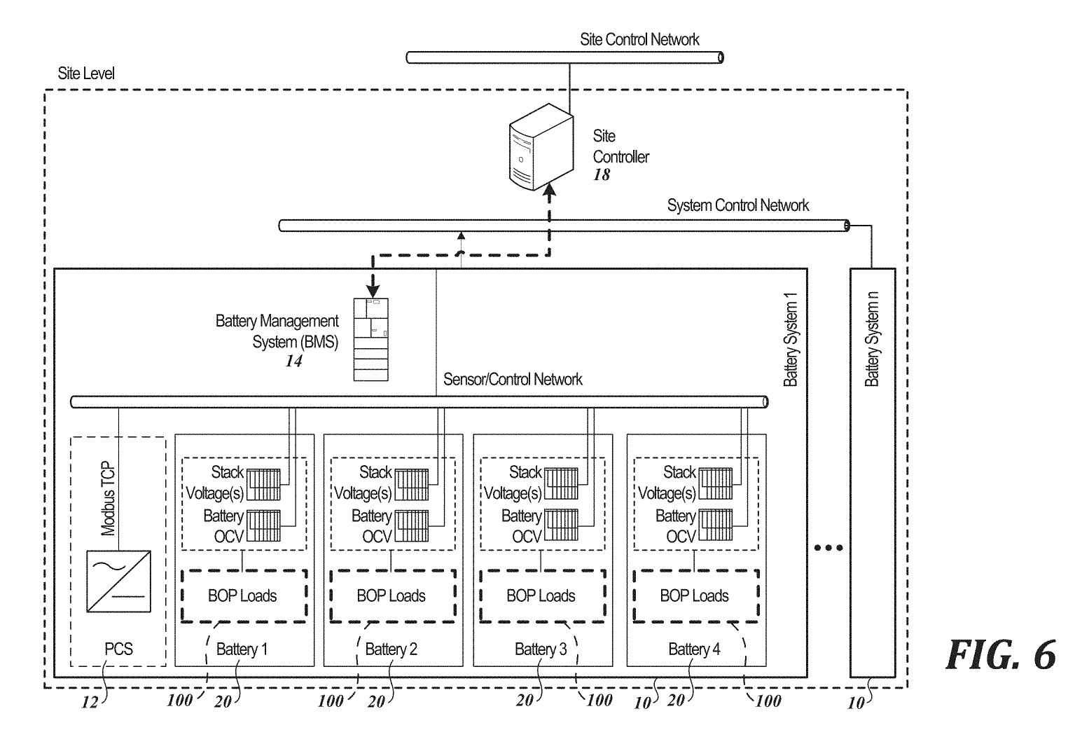

As noted above, a string 10 is a building block for a multiple MW site. As seen in the exemplary layouts in FIGS. 4 and 5, each string 10 includes four battery containers connected in series to a power and control system (PCS) 12 container. As can be seen in FIG. 6, the control system for each string includes a battery management system (BMS) 14 with local control provided, for example, by a human machine interface (HMI). The BMS 14 interprets remote commands from the site controller 18, for example, a customer requirement to charge or discharge, as it simultaneously directs the appropriate operations for each battery and sub-component in the string 10 via a communication network. At the same time, according to programmed logic, the BMS 14 interprets string 10 operating data from the batteries 20, PCS, and their associated sub-components to evaluate service or diagnose maintenance requirements. See also FIG. 6 for string and site control diagrams.

As a non-limiting example, an exemplary VRB may have capacity up to 125 kW for four hours (500 kW-hours) and a storage string may have capacity up to 500 kW for four hours (2 MW-hours). To be effective as a large scale energy storage system that can be operated to provide multiple layered value streams, individual batteries, designed and manufactured to meet economies of scale, may be assembled as building blocks to form multiple-megawatt sites, for example 5 MW, 10 MW, 20 MW, 50 MW, or more. Managing these large installations requires multi-level control systems, performance monitoring, and implementation of various communications protocols.

Referring to FIG. 4, an exemplary 1 MW system layout shows two 500 kW building block sub-assemblies or strings 10 that each include four battery modules 20 and one PCS module 102. Using this approach, multi-level larger systems may be assembled, for example, the single-level 10 MW system shown in FIG. 5. As described in greater detail below, the unique combination of systems and components described herein provide significantly more energy density in a compact flowing electrolyte battery module 20 and string 10 design than previously designed flowing electrolyte batteries, such earlier generation VRBs. Other hybrid flowing electrolyte batteries, such as ZnBr2 systems, may demonstrate similar characteristics.

### Battery Container System, Electrolyte Tank Assembly, and General Arrangement

Referring now to FIGS. 1 and 2 each RFB 20 includes a container 50 that houses the remaining components of the system in a substantially closed manner. These remaining components generally include the anolyte and catholyte tank assemblies 22 and 24, the stacks of electrochemical cells 30, 32, and 34, a system for circulating electrolyte 40, and an optional a gas management system 94. The configuration of each of these components will now be described in more detail.

FIG. 1 depicts the container 50 that houses, for example, the components shown in FIG. 2. The container 50 can be configured in some embodiments to be an integrated structure that facilitates or provides one or more of the following characteristics: compact design, ease of assembly, transportability, compact multiple-container arrangements and structures, accessibility for maintenance, and secondary containment.

In the illustrated embodiment of FIGS. 1 and 2, the representative container 50 comprises two major compartments that house components of the RFB 20. In some embodiments, the division between the first and second compartments 60 and 62 is a physical barrier in the form of a bulkhead 70 (see FIG. 3B), which may be a structural or non-structural divider. The bulkhead 70 in some embodiments can be configured to provide secondary containment of the electrolyte stored in tank assemblies 22 and 24. In another embodiment, a secondary structural or non-structural division can be employed to provide a physical barrier between the anolyte tank 22 and the catholyte tank 24. In either case, as will be described in more detail below, the tanks 22 and 24 are configured as so to be closely fitted within the compartment or compartments, thereby maximizing the storage volume of electrolyte within the container 50, which is directly proportional to the energy storage of the battery 20.

In some embodiments, the container 50 has a standard dimensioning of a 20 foot ISO shipping container. In one representative embodiment shown in FIGS. 1 and 2, the container has a length A which may be 20 feet, 8 feet in width B, and 9½ feet in height C, sometimes referred to as a High-Cube ISO shipping container. Other embodiments may employ ISO dimensioned shipping containers having either 8 feet or 8½ feet in height C, and in some embodiments, up to 53 feet in length A. In some of these embodiments, the container 50 can be additionally configured to meet ISO shipping container certification standards for registration and ease of transportation via rail, cargo ship, or other possible shipping channels. In other embodiments, the container may be similarly configured like an ISO shipping container. In other embodiments, the container has a length in the range of 10-53 feet and a height in the range of 7-10 feet.

The container 50 also includes various features to allow for the RFB 20 to be easily placed in service and maintained on site. For example, pass-through fittings are provided for passage of electrical cabling that transfers the power generated from circulation of the anolyte and the catholyte through the stacks of electrochemical cells. In some embodiments, the container 50 includes an access hatch 80, as shown in FIG. 1. Other hatches, doors, etc. (not shown) may be included for providing access to systems of the RFB 20.

### String Capacity Management of Electrolyte

Passive capacity management techniques have been shown to maintain stable performance under most conditions for a single battery. However, other operating conditions may occur that require active capacity management, especially on the string and site level.

Described herein are systems and methods of operation designed for improving performance on a string and site level. For example, in some embodiments of the present disclosure, performance can be improved by matching the state of charge when a string includes multiple batteries having different states of charge. In other embodiments of the present disclosure, when an islanded system is turned off, stored energy can be preserved and used to restart the system on its own.

In one example, stack variation caused by differences in manufacturing assembly and materials may produce slightly different performance characteristics between each of the four RFBs 20 in a string 10 (see exemplary string diagrams in FIGS. 2 and 6), in some cases leading to different membrane ion transfer capabilities or different levels of side reactions, both of which contribute to performance mismatch in a string of batteries. One mechanism that may be affected by manufacturing differences in stacks can be seen during battery operation in the way ions travel back and forth through the membrane separating positive and negative electrolytes as they form a closed electrical circuit, and in the way water molecules travel through the membrane together with other hydrated ions or by themselves. As a result of stack differences, the volume of the positive and negative electrolytes and the concentrations of active ions in the electrolytes may change at different rates during battery operation.

In another example, stack variations caused by damage (leakage, blockage, etc.) to one or more stack cells may produce slightly different performance characteristics when the stacks are assembled as batteries and strings, and may also cause an imbalance in the predetermined battery tank volume ratio described above. Other reasons for stack variation may include differences in the electrode, stack compression, etc.

Because there may be performance differences between batteries in a string and all batteries in a string are electrically connected for charge and discharge operations, the worst performing battery may determine the performance of the string. Further, because each battery in the string has dedicated electrolyte tanks, lower performing batteries may continue to experience declining performance caused, for example by the by stack variation described above. Declining battery capacity is generally indicative of or may lead to electrolyte stability and capacity problems for the associated string. If left unchecked, these performance variations may result in decreased capacity across a string (or a site).

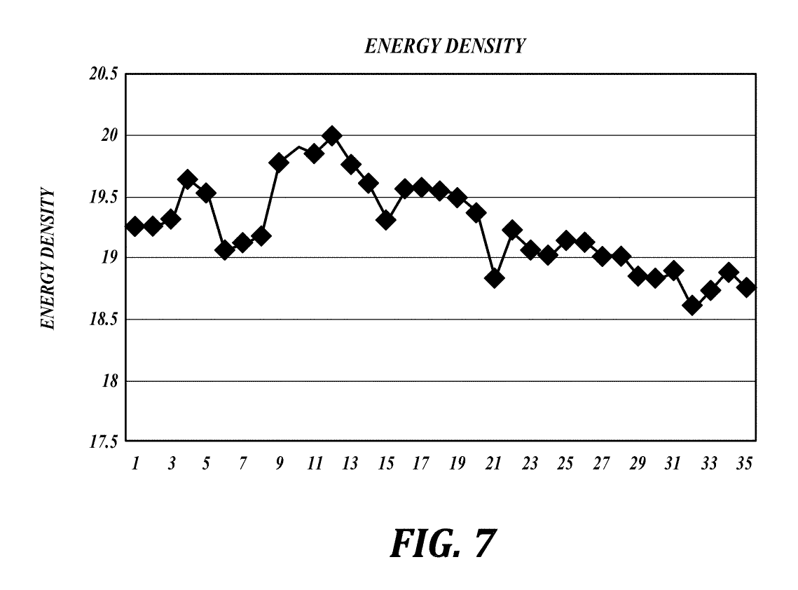

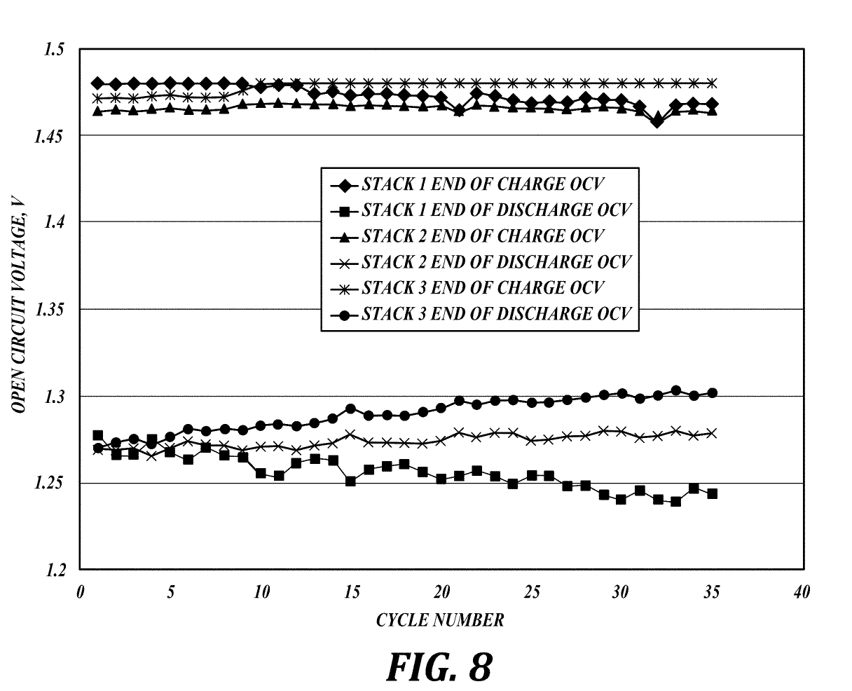

The possible effect of decreasing performance of one or more batteries in a string is illustrated below with reference to FIGS. 7 and 8, using data based on open circuit voltage (OCV) values measured on the cell, stack, and battery level for each RFB in a string. OCV directly corresponds to SOC and is one measure of the state-of-charge (SOC) of a vanadium redox flow battery (VRFB), and is defined as the difference in electrical potential between two terminals of a device when it is disconnected from the circuit, for example, selected anolyte and catholyte reference points for each redox flow battery. For example, in a string of three, series-connected, kW-scale batteries without capacity management adjustments, a steady decline in energy density over 35 cycles can be seen in FIG. 7. In a string of three, series-connected, kW-scale batteries without capacity management adjustments, a steady deviation in OCV at the end of discharge over 35 cycles can be seen in FIG. 8.

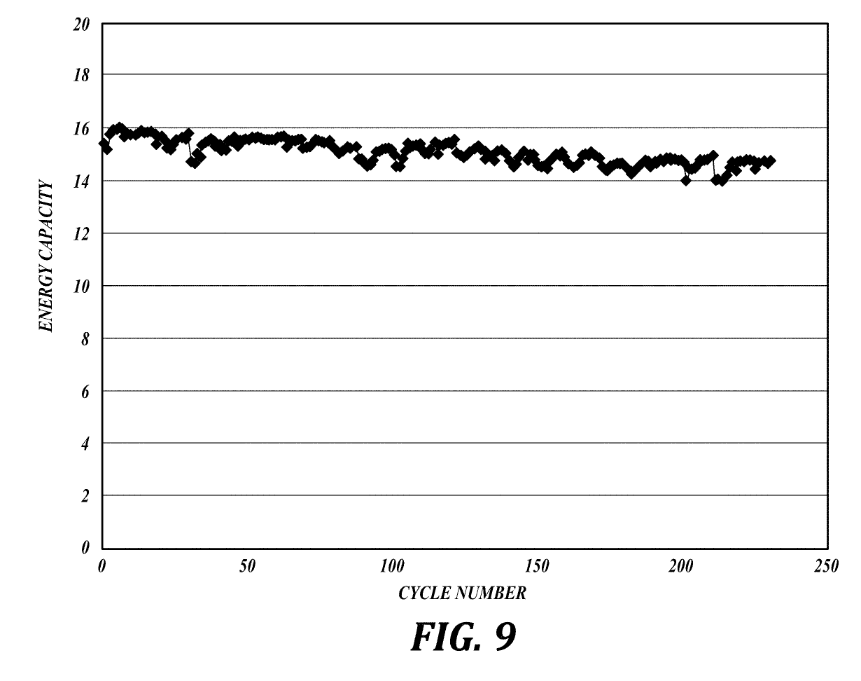

Matching SOC in a string mitigates performance degradation of a battery string, as illustrated below in FIG. 9. In a string of three, series-connected, kW-scale batteries with capacity management adjustments, the energy density decline of about 7% is shown in FIG. 9 for over 200 cycles. As compared to the energy density decline in FIG. 7 of about 7% over only 35 cycles, matching operation mitigates performance degradation effects in one or more batteries in a string.

### Active Electrolyte State-Of-Charge (SOC) Measurements

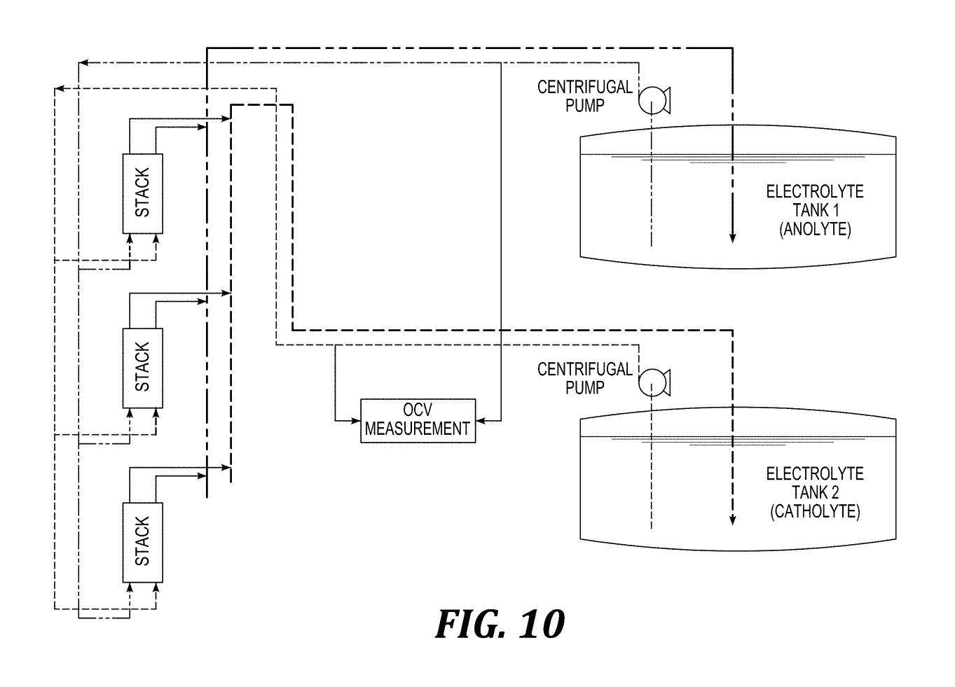

To manage battery capacity on the string (or site) level, state-of-charge (SOC) values are determined for each RFB. See FIG. 6 showing “Battery OCV” determinations for each battery in the string. As one non-limiting example in a vanadium redox flow battery (VRFB), SOC can be determined using an open circuit voltage (OCV) measurement, which is the difference in electrical potential between two terminals of a device when it is disconnected from the circuit. For example, as shown in FIG. 10, OCV for a VRFB can be measured using a small electrochemical cell as the potential between the anolyte and catholyte solutions.

Other ways of determining SOC besides OCV are also within the scope of the present disclosure, such as recording and analyzing the amount of energy entering and leaving the battery over a given time period, which may be referred to as coulomb counting.

### Determining Target State-Of-Charge (SOC) Value

After determining SOC, a selected SOC value can be determined as a target value for the other batteries in the system. Therefore, the other RFBs in the string can then be adjusted to correspond to the selected SOC value. The target SOC value is a function of the SOC values for all of the plurality of redox flow batteries in the string. As a non-limiting example, the target SOC value may be the lowest SOC value in the string. As another non-limiting example, the target SOC value may be an average string SOC, which may or may not omit the underperforming battery from the calculations. As another non-limiting example, the target SOC value may be a maximum deviation from the average string SOC value. As another non-limiting example, the target SOC value may be a target SOC value determined by an algorithm based on conditions in the string. The target SOC value may be a conditional value based on transient operating parameters.

In a dynamic system, the predetermined or target value will change continually based on changing conditions in the string. The target SOC value may be subject to change based on one or more of the following conditions: low SOC; an unusually large load on the system; high discharge; and other external conditions. Adjusting the target SOC may be controlled by the battery management system (BMS) during battery operation or may be performed during maintenance of the redox flow battery.

### Adjusting SOC to Match State-Of-Charge in a Battery String

In accordance with embodiments of the present disclosure, a method of operating a redox flow battery string is provided. The string includes a plurality of redox flow batteries, for example, at least first and second redox flow batteries. The string also includes an outside power source that provides power to operate the string.

The outside power source may be a main power source, such as a grid, or may be a secondary power source, such as a non-grid power source, for example, a generator or other auxiliary power device.

The plurality of redox flow batteries in the string are electrically connected in series or parallel.

In accordance with embodiments of the present disclosure, one exemplary method for adjusting the SOC value for at least one of the redox flow batteries in the string to correspond to the target SOC value includes using a portion of the stored energy in the at least one redox flow battery to supply power to the electrical load that operates the at least one redox flow battery. In one embodiment of the present disclosure, adjusting the SOC value for at least one redox flow battery in the string to correspond to the target SOC value includes reducing the SOC value for at least one redox flow battery in the string to correspond to the target SOC value.

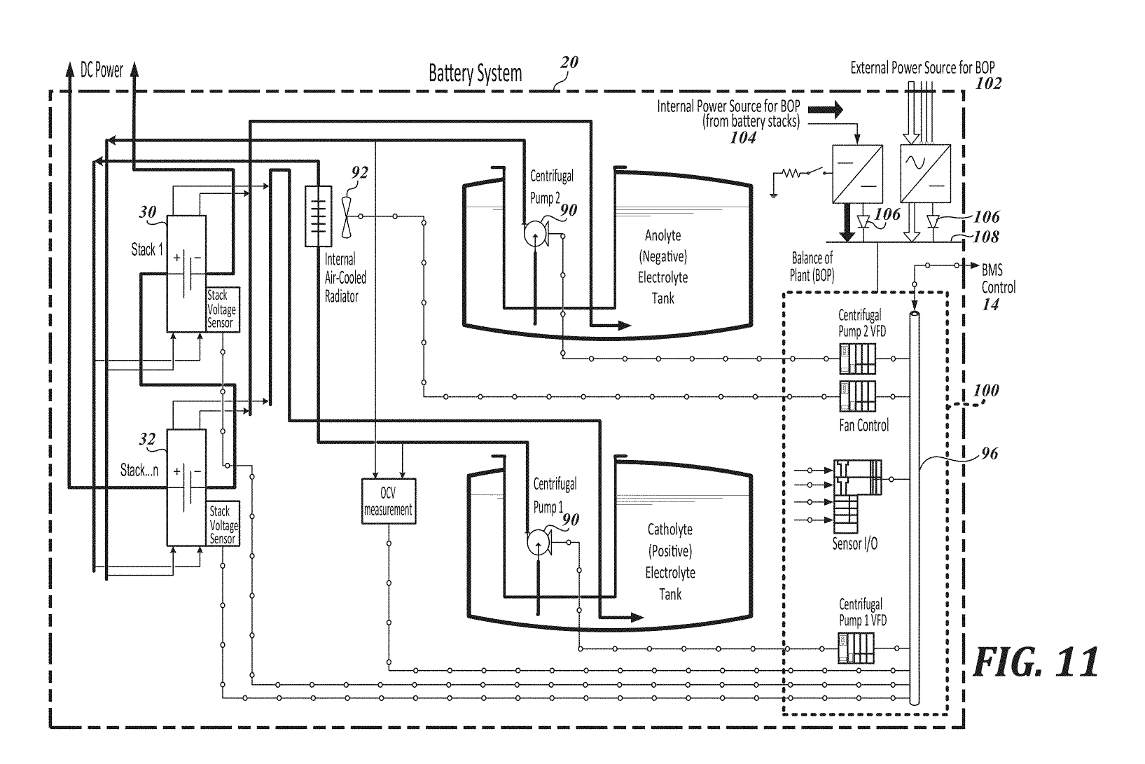

The electrical load, also referred to as the balance-of-plant (BOP) load, for the exemplary 125 kW redox flow battery shown in FIG. 4 is approximately 3 kW. Referring to FIGS. 6 and 11, the exemplary BOP load comprises auxiliary power required for operating battery component equipment such as the anolyte and catholyte electrolyte pumps 90, cooling system fans 92, instrumentation and electrical control systems 96, battery management system 14, etc. “BOP loads” 100 are shown for each redox flow battery in the string.

Supplying power to the electrical load that operates the at least one redox flow battery may include a portion of BOP load or all of the BOP loads for the RFB. For example, different components of the RFB system 20 (for example, those shown in FIG. 11) may be turned off or on to reduce or increase the BOP load.

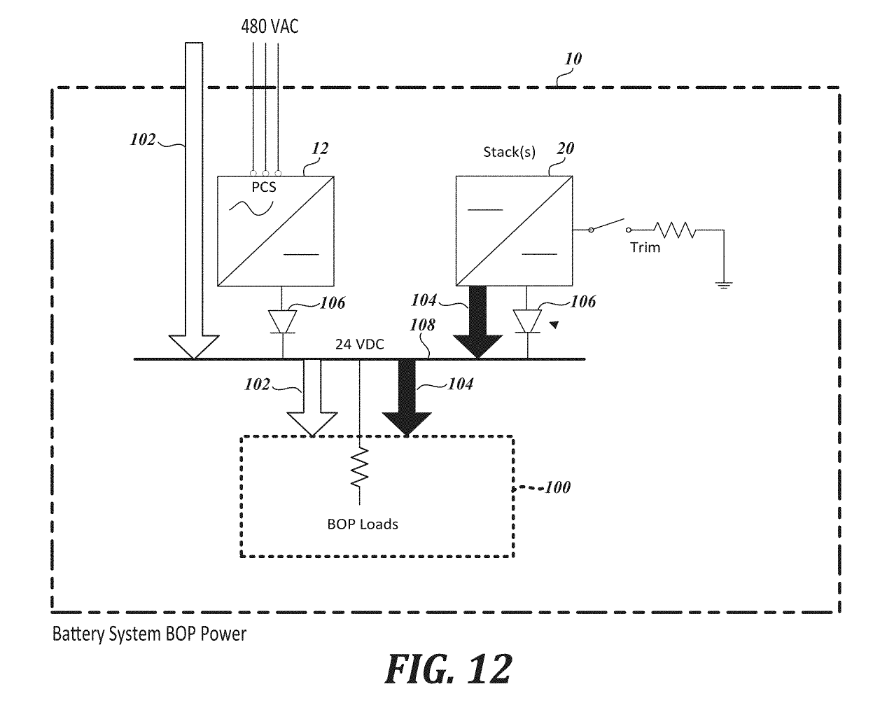

Referring to FIG. 12, the battery system has a dual feed control power system. In that regard, BOP loads 100 may be powered using an external power source 102 or an internal power source 104 derived from the energy stored in the redox flow battery system 20. In the illustrated embodiment of FIG. 12, power is only supplied from either an external power source 102 or an internal power source 104. However, a combination of power sources is within the scope of the present disclosure.

In the illustrated embodiment of FIG. 12, power is supplied to the BOP loads using a 24 VDC bus 108. Diodes 106 in the illustrated embodiment of FIG. 12 prevent the reverse flow of power.

Typically, the BOP load 100 is powered by an outside power source 102. When the SOC of a battery in a string is high relative to the other batteries, the stored energy in the battery from the internal power source 102 can be used to power its BOP load 100 to reduce the SOC of the battery. Therefore, at least one battery 20 in the string 10 uses stored energy in the battery to power its BOP load 100 and at least another battery in the string uses energy from an outside power source to power its BOP load.

Adjustment to reduce the SOC value of the battery having a high SOC value such that its SOC value is closer to a target value to provide a closer match of the SOC value(s) of the other batteries in the string. Such matching operation helps to mitigate performance degradation of a battery string.

### Islanded Power Systems

A main power grid is an interconnected network for delivering electrical power, typically produced by large-scale power stations. An islanded power system is a power system that operates, or is capable of operating, independent of a main power grid.

A micro-grid is one example of an islanded power system. A micro-grid is an islanded power system that is much smaller in scale than the main power grid. A micro-grid may be used, for example, to power remote facilities or communities where connections to the main power grid are unavailable, or to provide backup power in the event of an outage in the main power grid. A micro-grid may be coupled to the main power grid. A micro-grid may include a switch that allows the micro-grid to operate in a grid-connected mode or in an island mode to operate independent of the main power grid. Island mode can be useful, for example, when the main power grid (or a connection to the main power grid) is not functioning or is unreliable. Alternatively, a micro-grid may operate always in an island mode, such as in remote locations where connections to the main power grid are not available.

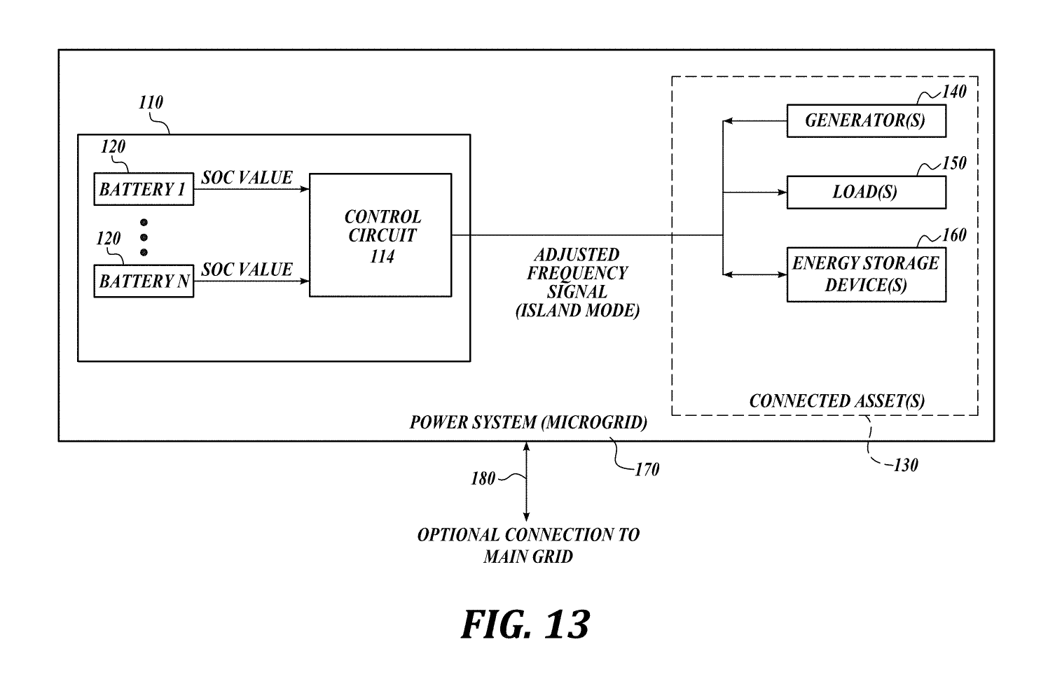

FIG. 13 is a block diagram of an illustrative micro-grid 170. In the example shown in FIG. 13, the micro-grid 170 includes a battery system 110 comprising a control circuit 114 (e.g., a BMS as described above) and one or more batteries 120 (e.g., a string of RFBs as described above). As shown, the battery system 110 is connected to one or more loads 150 (e.g., lighting systems, heating/cooling systems, or other electrical loads) on the micro-grid that can be powered by the battery system. The micro-grid 170 also may include other power sources such as one or more generators 140 (e.g., diesel generators, wind-powered generators) or other power sources (e.g., solar panel arrays), and/or one or more other energy storage devices 160 separate from the battery system 110, and/or one or more optional connected assets 130.

The micro-grid 170 also includes an optional connection 180 to a main power grid. If the optional connection 180 to the main power grid is present, the micro-grid also includes a switch (not shown) to allow the micro-grid to operate in a grid-connected mode or in an island mode.

### Managing Islanded Power Systems Using Battery State Of Charge and Frequency

In this section, illustrative embodiments are described that relate to an islanded power system (e.g., a micro-grid) comprising a battery system and at least one connected asset (e.g., a load, an energy storage device, or a generator or other power source). The battery system is configured to, in an island mode, make a frequency adjustment (i.e., an adjustment to the frequency of the oscillations of alternating current (AC) in the power system) based on a state of charge (SOC) of the battery system. The frequency adjustment signals the load, energy storage, or power generation of a connected asset that is electrically coupled to the battery system to be reduced or increased, depending on the adjustment. This allows the micro-grid to respond dynamically to changing conditions in the battery system. Although other islanded power systems may include assets that detect and respond to changes in voltage or frequency, described embodiments differ from prior systems at least in that they use the SOC of the battery system to calculate particular adjustments to be made.

As used in these examples, the term “signal” does not require a specific signal to be directed at a specific device. Rather, the term “signal” in this context refers to information (e.g., SOC information) that is implicit in the frequency adjustment. In this way, the signal can be broadcast (via the frequency adjustment) to connected assets within the islanded power system, which can take action based on the signal. As an example, consider a situation where SOC in the battery system is low, and a reduction in one or more loads is desired to help compensate for the low SOC. If it is known that a load will reduce power consumption in response to a decrease in frequency, the system can take advantage of this by decreasing frequency (e.g., by 1 Hz, 3 Hz, 5 Hz, etc.) when the SOC is low, and thereby signal the load to be decreased. The system need not send any other information about the SOC to the load. By manipulating the frequency based on the SOC, the system can cause assets to react by increasing or decreasing power, as may be appropriate based on the SOC.

Referring again to FIG. 13, the illustrative micro-grid 170 manages one or more connected assets 130 using SOC and frequency. The battery system 110 is connected to one or more connected assets, such as loads 150 (e.g., lighting systems, heating/cooling systems, or other electrical loads), generators 140 or other power sources, and/or one or more other energy storage devices 160 separate from the battery system 110. As shown in FIG. 13, the batteries 120 provide SOC values to the control circuit 114. In an island mode, the control circuit 122 generates an adjusted frequency signal based on the SOC values. One or more of the connected assets responds to the adjusted frequency with an increase or decrease in power, as appropriate. Alternatively, instead of using the control circuit 114 (e.g., a BMS, as described above) of the battery system 110 to effect the frequency adjustment, the battery system may provide SOC information to some other module, such as a separate power conversion and control module (not shown in FIG. 13) within or outside the battery system 110, to effect the frequency adjustment.

In least one embodiment, a connected asset responds to a threshold change in frequency with a predetermined action, such as a predetermined decrease or increase in power. In an illustrative scenario, a decrease of 3 Hz or more (indicating a low SOC) may cause a connected load to reduce power by a predetermined amount, whereas an increase of 3 Hz or more (indicating a high SOC) may cause the connected load to be maintained, or increased by a predetermined amount. Similarly, a decrease of 3 Hz or more may cause a connected generator or energy storage device to increase power output by a predetermined amount, whereas an increase of 3 Hz or more may cause the connected generator or energy storage device to decrease power output by a predetermined amount. Alternatively, the magnitude of the change in power may depend on the magnitude of the change in frequency. For example, a decrease of between 3 and 5 Hz may cause a connected load to reduce power by a first amount, whereas a decrease of more than 5 Hz may cause the connected load to decrease power by a second, larger amount.

The SOC may be evaluated against one or more predefined ranges to determine an action (e.g., increase or decrease in power, or no change) for the asset to take. In at least one embodiment, for VRFB batteries, the total available range of SOC is determined by the chemistry of the batteries, and is directly measured as a voltage in the useful range of approximately 1.25-1.6V. Other batteries may have different values or other methods of determining the SOC.

In a battery system with one battery, the SOC that is used in the calculation may simply be the SOC for that battery. In a battery system with two or more batteries, the SOC that is used in the calculation can be the average SOC for all batteries in the battery system, or some other value. Whatever the actual value of the SOC may be, an appropriate adjustment to frequency can be made to cause an appropriate response from a connected asset.

Frequency adjustment may be calculated or determined automatically as a function of the SOC. For example, referring to Table 1, below, an acceptable SOC range for the exemplary battery system 110 may be in the range of 30%-70%. In this range, there may be no frequency adjustment. Frequency adjustment set points may be programmed into the control circuit 114 using tabulated information as illustrated in Table 1, below, where the connected assets may react individually or as a group, depending on their control characteristics and the frequency of the power system (micro-grid) 170.

TABLE 1

| Battery System | Frequency | |
|---|---|---|
| SOC | Adjustment | Action(s) |
| Above 80% | +5 Hz | May affect multiple connected assets |
| 70%-80% | +3 Hz | May affect single connected asset |
| 30%-70% | 0 Hz | No effect on connected assets |
| 20%-30% | −3 Hz | May affect single connected asset |
| Below 20% | −5 Hz | May affect multiple connected assets |

Note that it is also possible to use the magnitude and/or rate of change of the frequency to affect a desired mode of operation for a specific connected asset. In the example shown in Table 1, SOC values that are further outside the acceptable range (e.g., above 80% or below 20%) may cause a larger frequency adjustment as well as affecting more than one connected asset (if more than one asset is connected to the power system 170). In one possible scenario, a generator is tuned to respond to a frequency adjustment of 3 Hz or more, while a load is tuned to respond to a frequency adjustment of 5 Hz or more. In such a scenario, a frequency adjustment of 3 Hz would affect the generator, but not the load, while a frequency adjustment of 5 Hz would affect both the generator and the load.

The particular increase or decrease in frequency that is chosen is not necessarily important, but in practice the increase or decrease may be limited by the characteristics of the power system and the ability of connected assets to detect and respond to the change without adversely affecting performance of the system. In described embodiments, the change in frequency may be, for example, 5 Hz or less, and may be an increase or decrease of 3 Hz, an increase or decrease of 1 Hz, or some other value. The resulting frequency after the increase or decrease may depend on the standard frequency of the power system. For example, in North America, the standard frequency is 60 Hz, whereas in other parts of the world, the standard frequency may be 50 Hz or some other frequency. Typically, the frequency adjustment will continue until the SOC value returns to a set point or an allowable operating band, for example 30%-70%, that is no longer high enough or low enough to trigger the adjustment, at which point the frequency will return to a set point or an allowable operating band, for example 59.9 Hz-60.1 Hz.

Any connected asset that exhibits predictable behavior in response to frequency changes in the power system 170 can be used to take advantage of this signaling technique. Well documented examples of equipment that exhibits predictable behavior in response to frequency changes include generator droop control and solar generation frequency/watt curtailment. Connected assets that do not increase or reduce power in response to the described frequency adjustments also can be connected to the battery system without affecting the ability of other assets to respond to the signaling technique.

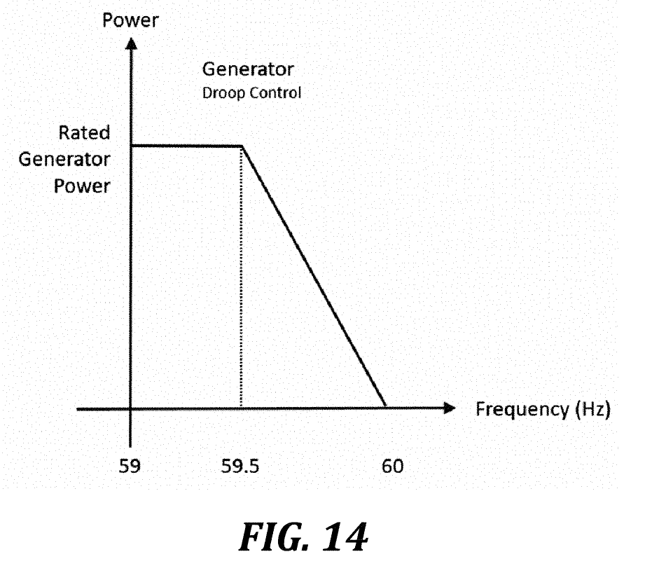

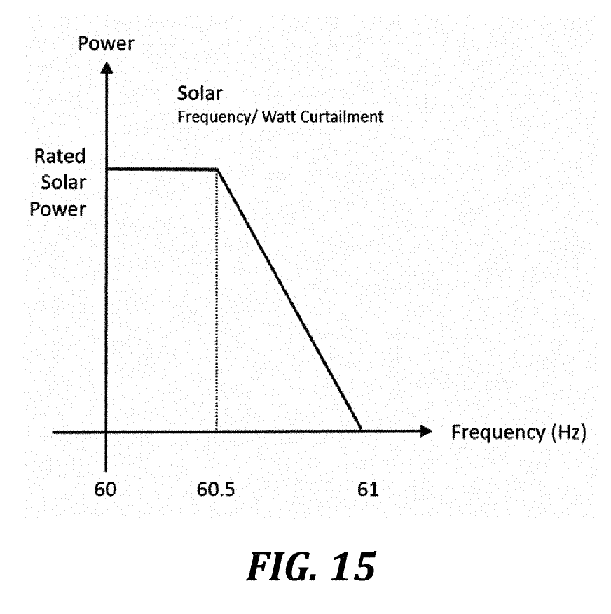

FIGS. 14 and 15 are graphs that illustrate power versus frequency characteristics of two exemplary connected assets. FIG. 14 is a graph for a diesel generator as a connected asset with connected loads, and FIG. 15 is a graph for solar power generation—a solar PV (photovoltaic) array as a connected asset with connected loads. The graphs show how each asset reacts to frequency changes by decreasing or increasing power. Defining shapes for each curve are typically programmed into the connected asset's control system according to the combined operating characteristics of the power system. These characteristics can be collectively taken into account when planning the power system.

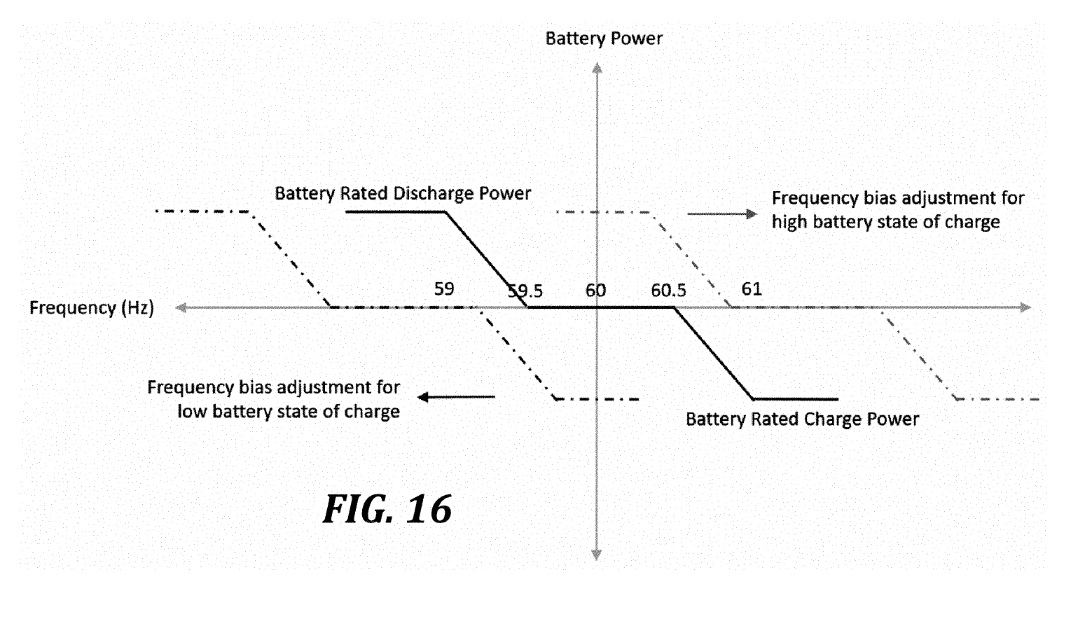

The exemplary graph in FIG. 16 shows how adjusting the frequency of the power system may cause connected assets to change operating state. Curve #1 (center) shows that there is no frequency adjustment for a 50% battery state of charge. The left-most curve (Curve #2) shows that when there is a low state of charge (e.g., less than 30%), frequency shifts so that the value falls into the operating range of the connected generating asset, thus initiating battery charging, which is shown in FIG. 14 as a range between 59.5 Hz and 60 Hz. The right-most curve (Curve #3) shows that when there is a high state of charge (e.g., greater than 70%), frequency shifts so that the value falls into the operating range of a connected generating asset to stop charging the battery, as illustrated for a solar generating asset in FIG. 15, where power curtailment occurs between 60.5 Hz and 61 Hz. Alternatively, other frequency adjustment ranges can be used to cause connected assets to change operating state.

While illustrative embodiments have been illustrated and described, it will be appreciated that various changes can be made therein without departing from the spirit and scope of the invention.

The embodiments of the invention in which an exclusive property or privilege is claimed are defined as follows:

1. A battery system comprising:
a battery management system; and
at least a first battery,
wherein the battery system is operable in an island mode in which the battery system sets voltage and frequency for the power system, wherein the battery management system is configured to, in the island mode, cause a frequency adjustment to the voltage in the power system based on a state of charge of the battery system, and wherein the frequency adjustment signals one or more connected assets electrically coupled to the battery system to reduce or increase power based on the frequency adjustment.

2. The battery system of claim 1, wherein the one or more connected assets electrically coupled to the battery system are selected from the group consisting of load, generator, and energy storage device.

3. The battery system of claim 1, wherein the frequency adjustment is associated with the state of charge being below a threshold value.

4. The battery system of claim 3, wherein the one or more connected assets comprise a load, and wherein the frequency adjustment signals the load to be decreased.

5. The battery system of claim 3, wherein the one or more connected assets comprise a generator, and wherein the frequency adjustment signals power generation of the generator to be increased.

6. The battery system of claim 3, wherein the one or more connected assets comprise an energy storage device, and wherein the frequency adjustment signals power output of the energy storage device to be increased.

7. The battery system of claim 1, wherein the frequency adjustment is associated with the state of charge being above a threshold value.

8. The battery system of claim 7, wherein the one or more connected assets comprise a load, and wherein the frequency adjustment signals the load to be maintained or increased.

9. The battery system of claim 7, wherein the one or more connected assets comprise a generator, and wherein the frequency adjustment signals power generation of the generator to be decreased.

10. The battery system of claim 7, wherein the one or more connected assets comprise an energy storage device, and wherein the frequency adjustment signals power output of the energy storage device to be decreased.

11. The battery system of claim 1, wherein the frequency adjustment is calculated automatically as a function of the state of charge.

12. The battery system of claim 11, wherein calculation of the frequency adjustment is based on magnitude and rate of change of the state of charge.

13. The battery system of claim 1, wherein the frequency adjustment comprises an increase or decrease of 5 Hz or less.

14. The battery system of claim 13, wherein the frequency adjustment comprises an increase or decrease of approximately 3 Hz.

15. The battery system of claim 13, wherein the frequency adjustment comprises an increase or decrease of approximately 1 Hz.

16. The battery system of claim 1, wherein the state of charge of the battery system is associated with the first battery.

17. The battery system of claim 1, wherein the battery system comprises two or more batteries.

18. The battery system of claim 17, wherein the state of charge of the battery system is calculated as a function of charge of the two or more batteries.

19. The battery system of claim 17, wherein the state of charge of the battery system is calculated as an average charge of the two or more batteries.

20. The battery system of claim 1, wherein the first battery is a redox flow battery.

21. The battery system of claim 1, wherein the first battery is a vanadium redox flow battery.

22. A power system comprising:
a battery management system;
at least a first battery, and
a power conversion and control module,
wherein the battery management system is operable to, in an island mode, send state of charge information to the power conversion and control module, wherein the power conversion and control module is operable to cause a frequency adjustment to the voltage in the power system based on the state of charge information, and wherein the frequency adjustment signals one or more connected assets electrically coupled to the power system to reduce or increase power based on the frequency adjustment.

23. The power system of claim 22, wherein the one or more connected assets are selected from the group consisting of load, generator, and energy storage device.
